(19) United States
(12) Patent Application Publication
(10) Pub. No.: US 2020/0022372 A1
(43) Pub. Date: Jan. 23, 2020

(54) LOW TEMPERATURE STABLE FORMULATIONS OF UREASE INHIBITOR-CONTAINING COMPOSITIONS

(71) Applicant: Koch Agronomic Services, LLC, Wichita, KS (US)

(72) Inventors: Ethel Garnier-Amblard, Wichita, KS (US); Douglas Barr, Wichita, KS (US)

(21) Appl. No.: 16/515,118

(22) Filed: Jul. 18, 2019

Related U.S. Application Data
(60) Provisional application No. 62/700,665, filed on Jul. 19, 2018.

(51) Int. Cl. A01N 57/28

(52) U.S. Cl. CPC A01N 57/28

(57) ABSTRACT

The present disclosure relates to formulations comprising a urease inhibitor with improved stability against crystallization and/or freezing upon exposure to low temperatures, such as for example, 0° C. or below. The present disclosure also provides methods to make and use such a formulation.

### FIELD OF THE DISCLOSURE

The present disclosure relates to formulations comprising a urease inhibitor with improved stability against crystallization and/or freezing upon exposure to low temperatures, such as for example, 0° C. or below. The present disclosure also provides methods to make and use such a formulation.

### BACKGROUND

Fertilizers have been used for some time to provide nitrogen to the soil. The most widely used and agriculturally important nitrogen fertilizer is urea, CO(NH₂)₂. Most of the urea currently produced is used as a fertilizer in its granular (or prilled) form. After application of urea to soil, it is readily hydrolyzed to yield ammonia and carbon dioxide. This process is catalyzed by the enzyme urease, which is produced by some bacteria and fungi that may be present in the soil. The gaseous products formed by the hydrolysis reaction (i.e., ammonia and carbon dioxide) can volatilize to the atmosphere and thus, substantial losses from the total amount of the nitrogen applied to the soil can occur.

Attempts to reduce losses of applied nitrogen have utilized urease inhibitors and/or nitrification inhibitors as additives to the fertilizer. Urease inhibitors are compounds capable of inhibiting the catalytic activity of the urease enzyme on urea in the soil. Nitrification inhibitors are compounds capable of inhibiting the bacterial oxidation of ammonium to nitrate in the soil. Urease inhibitors and nitrification inhibitors can be associated with fertilizers in various ways. For example, they can be coated onto fertilizer granules or mixed into fertilizer matrices. A number of granulation methods are known, including falling curtain, spherudization-agglomeration drum granulation, prilling and fluid bed granulation technologies.

Examples of urease inhibitors are the thiophosphoric triamide compounds disclosed in U.S. Pat. No. 4,530,714 to Kolc et al., which is incorporated herein by reference. The disclosed thiophosphoric triamide compounds include N-(n-butyl)thiophosphoric triamide (NBPT), the most developed representative of this class of compounds. When incorporated into a urea-containing fertilizer, NBPT reduces the rate at which urea is hydrolyzed in the soil to ammonia. The benefits realized as a result of the delayed urea hydrolysis include the following: (1) nutrient nitrogen is available to the plant over a longer period of time; (2) excessive build-up of ammonia in the soil following the application of the urea-containing fertilizer is avoided; (3) the potential for nitrogen loss through ammonia volatilization is reduced; (4) the potential for damage by high levels of ammonia to seedlings and young plants is reduced; (5) plant uptake of nitrogen is increased; and (6) an increase in crop yields is attained. NBPT is commercially available for use in agriculture and is marketed in such products as the AGROTAIN® nitrogen stabilizer product line.

Industrial grade NBPT is a solid, waxy compound, and decomposes by the action of water, acid and/or elevated temperature. In particular, NBPT is believed to degrade at elevated temperatures into compounds that may not provide the desired inhibitory effects on the urease enzyme. Accordingly, its combination with other solid materials to provide a material capable of inhibiting urease, particularly via granulation with urea (which generally employs heat) can be challenging. Further, NBPT and compositions comprising NBPT are reasonably stable under normal storage conditions (such as room temperature and neutral pH), but it is known that acidic conditions may lead to rapid disappearance of NBPT. See, for example, Engel et al., Apparent persistence of N-(n-butyl)thiophosphoric triamide is greater in alkaline soils, Soil Science Society of America Journal 77(4), 1424-1429 (2013). Certain techniques have been pursued to slow the degradation of NBPT but have shown limited efficacy.

### SUMMARY OF THE INVENTION

While urease inhibitor containing formulations have various advantages, including reducing the loss of nitrogen to the environment, such formulations can be difficult to handle in cooler climates where crystallization or freezing is common. As a result, there is a need to develop formulations, including those that are stable at lower temperatures, such as at 0° C. or lower. It is also advantageous that such formulations do not include N-methyl-2-pyrrolidone (NMP).

The present disclosure provides a formulation comprising at least one urease inhibitor adduct comprising a urease inhibitor with urea, formaldehyde, or both urea and formaldehyde; and a urease inhibitor, wherein the composition has a freezing point ranging from −20° C. to 0° C. The present formulations may also include a solvent, such as organic solvents, that provide high solubility and stability of urease inhibitor adducts in the solvent, resistance of the resulting solution against crystallization or freezing at a low temperature, low viscosity of the solution, low toxicity, low volatility and flammability, and low cost. The formulations of the present disclosure can be formulated without N-methyl-2-pyrrolidone (NMP) but nevertheless demonstrate comparable low-temperature stability to urease inhibitor compositions prepared with NMP.

Formulations of the present disclosure may further comprise formaldehyde, a nitrification inhibitor, such as dicyandiamide (DCD), a nitrogen source, such as urea, and additional excipients and/or additives. The formulations of the present disclosure may also include a dye. The formulations of the present disclosure have been found to overcome the tendency of dye to expedite crystallization of certain components or freezing of the whole solution at lower temperatures. The present formulations allow for the use of common dyes, including food dyes.

The present disclosure also includes a method for lowering or depressing the freezing point of formulations comprising at least one urease inhibitor adduct comprising a urease inhibitor with urea, formaldehyde, or both urea and formaldehyde and a urease inhibitor. According to the present disclosure, it has been recognized that compositions comprising urease inhibitors with at least one urease inhibitor adduct (as will be detailed more thoroughly herein below) exhibit enhanced stability.

### DETAILED DESCRIPTION OF THE INVENTION

As disclosed herein, methods for enhancing the low temperature stability of urease inhibitors and compositions comprising urease inhibitors are provided. Such methods generally comprise combining the urease inhibitor, with a urease inhibitor adduct, which is a urease inhibitor (e.g., N-(n-butyl)thiophosphoric triamide, NBPT) and/or urea and/or an aldehyde. The reaction product generally comprises one or more structurally different adducts of the urease inhibitor with urea and/or the aldehyde (referred to herein as urease inhibitor adducts). Such adduct forms, as will be further described and demonstrated herein, can effectively serve to “protect” the urease inhibitor from certain routes of degradation, enhancing the stability of the urease inhibitor (and compositions containing the urease inhibitor) over time.

The present disclosure also includes a fertilizer composition comprising a urease inhibitor adduct and a urease inhibitor, with or without a solvent, and a nitrogen source. When such a fertilizer is applied to the soil, the fertilizer composition exhibits slower degradation of the urease inhibitor than a comparable fertilizer composition comprising the urease inhibitor, and a nitrogen source. The nitrogen source can be selected from the group consisting of solid free urea, urea ammonium nitrate, and urea formaldehyde polymer. Another suitable urea source can be or can include animal waste(s) such as urine and/or manure produced by one or more animals, e.g., cows, sheep, chickens, buffalo, turkeys, goats, pigs, horses, and the like.

Such fertilizer compositions can, in some embodiments, comprise about 90% by weight or more urea, about 98% by weight or more urea, or about 99% or more by weight urea. Fertilizer compositions can comprise various additional components, e.g., one or more materials selected from the group consisting of free urease inhibitor, free formaldehyde, formaldehyde equivalents, urea formaldehyde polymer (UFP), water, and combinations thereof. In certain embodiments, the fertilizer composition comprises substantially no dicyandiamide (DCD). In other embodiments, the fertilizer composition of the present disclosure includes dicyandiamide (DCD).

The disclosure further provides a method of preparing a urease inhibitor composition wherein the urease inhibitor exhibits enhanced stability, including low temperature stability, comprising: combining a urease inhibitor, urea, and formaldehyde to form an adduct of the urease inhibitor with urea, formaldehyde, or both urea and formaldehyde; and further combining with a urease inhibitor and optionally a solvent. In at least one embodiment, the urease inhibitor composition does not include NMP. The disclosure additionally provides a method of preparing a urease inhibitor composition wherein the urease inhibitor exhibits a reduced rate of degradation, and enhanced low temperature stability comprising: combining a urease inhibitor, urea, and formaldehyde to form an adduct of the urease inhibitor with urea, formaldehyde, or both urea and formaldehyde, and further combining with a urease inhibitor and optionally a solvent. In at least one embodiment, the urease inhibitor composition does not include NMP.

The formulations and methods disclosed herein are believed to be applicable across a range of urease inhibitors. However, in certain specific embodiments, the urease inhibitor is N-(n-butyl)thiophosphoric triamide (NBPT). The structures of the adduct or adducts involved in the present disclosure methods can vary. In some embodiments, the one or more urease inhibitor adducts comprise one or more adducts represented by the following formulas:

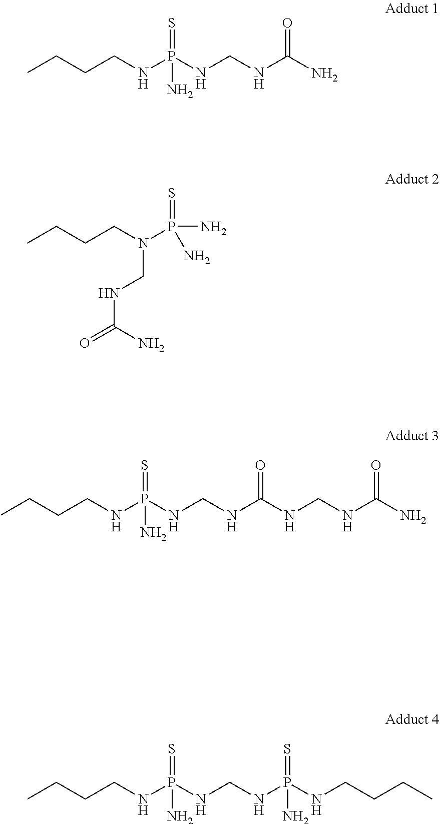 [SMILES: CCCCNP(N)(=S)NCNC(N)=O ; CCCCN(CNC(N)=O)P(N)(N)=S ; CCCCNP(N)(=S)NCNC(=O)NCNC(N)=O ; CCCCNP(N)(=S)NCNP(N)(=S)NCCCC]

In one aspect of the present disclosure, a method for enhancing the low temperature stability of a urease inhibitor composition is provided, comprising providing one or more urease inhibitor adducts comprising a urease inhibitor with urea, formaldehyde, or both urea and formaldehyde to a urease inhibitor and optionally a solvent.

In at least one embodiment, the disclosed methods for enhancing the low temperature stability of a urease inhibitor composition comprises providing a composition comprising at least one urease inhibitor adduct comprising a urease inhibitor with urea, formaldehyde, or both urea and formaldehyde; a urease inhibitor, and optionally a solvent, wherein the composition has a freezing point ranging from −20° C. to 0° C. In at least one embodiment, the solvent is not NMP.

In at least one embodiment, the urease inhibitor formulation of the present disclosure without NMP has a comparable low temperature stability to a formulation prepared with NMP.

The formulation of the present disclosure may include a urease inhibitor. As used herein, “urease inhibitor” refers to any compound that reduces, inhibits, or otherwise slows down the conversion of urea to ammonium (NH₄⁺) in soil when present as compared to the conversion of urea to ammonium (NH₄⁺) in soil when the urease inhibitor is not present. Examples of urease inhibitors include, but are not limited to, N-(n-butyl)thiophosphoric triamide (NBPT), N-(n-propyl)thiophosphoric triamide, N-(n-butyl)phosphoric triamide, N-(n-propyl)thiophosphoric triamide, N-(n-propyl)phosphoric triamide, thiophosphoryl triamide, phenylphosphorodiamidate, cyclohexyl phosphoric triamide, cyclohexyl thiophosphoric triamide, phosphoric triamide, hydroquinone, N-(2-nitrophenyl)phosphoric triamide, N-(2-pyrimidinyl)thiophosphoric triamide, N-phenylphosphoric triamide, 1,1,3,3,3-pentaamino-1λ5, 3λ5-diphosphaz-2-ene, p-benzoquinone, hexamidocyclotriphosphazene, thiopyridines, thiopyrimidines, thiopyridine-N-oxides, N,N-dihalo-2-imidazolidinone, N-halo-2-oxazolidinone and derivatives thereof.

In at least one embodiment, the urease inhibitor, such as for example, NBPT, is present in the formulation of the present disclosure, in an amount of from about 5% to about 95% by weight of the total weight of the formulation. The urease inhibitor may be present in the formulation of the present disclosure in an amount ranging from about 10% to about 90% by weight, such as from 15% to about 85%, such as from 20% to about 80%, such as from 25% to about 75%, such as from 30% to about 70%, such as from 35% to about 65%, such as from 40% to about 60%, such as from 45% to about 55%, or such as from 47% to about 52%. The urease inhibitor may be present in the formulation of the present disclosure in an amount of about 5%. The urease inhibitor may be present in the formulation of the present disclosure in an amount of about 10%. The urease inhibitor may be present in the formulation of the present disclosure in an amount of about 15%. The urease inhibitor may be present in the formulation of the present disclosure in an amount of about 20%. The urease inhibitor may be present in the formulation of the present disclosure in an amount of about 25%. The urease inhibitor may be present in the formulation of the present disclosure in an amount of about 30%. The urease inhibitor may be present in the formulation of the present disclosure in an amount of about 35%. The urease inhibitor may be present in the formulation of the present disclosure in an amount of about 40%. The urease inhibitor may be present in the formulation of the present disclosure in an amount of about 45%. The urease inhibitor may be present in the formulation of the present disclosure in an amount of about 50%. The urease inhibitor may be present in the formulation of the present disclosure in an amount of about 55%. The urease inhibitor may be present in the formulation of the present disclosure in an amount of about 60%. The urease inhibitor may be present in the formulation of the present disclosure in an amount of about 65%. The urease inhibitor may be present in the formulation of the present disclosure in an amount of about 70%. The urease inhibitor may be present in the formulation of the present disclosure in an amount of about 75%. The urease inhibitor may be present in the formulation of the present disclosure in an amount of about 80%. The urease inhibitor may be present in the formulation of the present disclosure in an amount of about 85%. The urease inhibitor may be present in the formulation of the present disclosure in an amount of about 90%. The urease inhibitor may be present in the formulation of the present disclosure in an amount of about 95%.

The formulation of the present disclosure also includes one or more urease inhibitor adducts. “Urease inhibitor adduct” as used herein refers to a reaction product resulting from reaction between one or more urease inhibitors and urea and/or an aldehyde. Such reaction products (comprising one or more structurally different adducts) retain at least portions of two or more of the reactants (i.e., urease inhibitor, urea, and/or aldehyde). Some urease inhibitor adducts are disclosed in U.S. patent application Ser. No. 15/349,512, filed Nov. 11, 2016, which is incorporated by reference herein in its entirety. One exemplary urease inhibitor adduct, which is not intended to be limiting, is an adduct formed from N-(n-butyl)thiophosphoric triamide (NBPT), and urea and/or an aldehyde (e.g., formaldehyde). Urease inhibitor adducts can be provided as-formed, can be purified to isolate one or more components therefrom, or can be provided in combination with one or more other components, such as additional urease inhibitor or a fertilizer composition, e.g., in the form of a nitrogen source including, but not limited to, a urea source.

A “urease inhibitor” that can be incorporated within the adducts is any compound that reduces, inhibits, or otherwise slows down the conversion of urea to ammonium (NH₄⁺) in soil. Exemplary urease inhibitors include thiophosphoric triamides and phosphoric triamides of the general formula (I)

X═P(NH₂)₂NR¹R² (I)

where X=oxygen or sulfur, and R¹ and R² are independently selected from hydrogen, C₁I-C₁₂ alkyl, C₃-C₁₂ cycloalkyl, C₆-C₁₄ aryl, C₂-C₁₂ alkenyl, C₂-C₁₂ alkynyl, C₅-C₁₄ heteroaryl, heteroalkyl, C₂-C₁₄ heteroalkenyl, C₂-C₁₄ heteroalkynyl, or C₃-C₁₂ cycloheteroalkyl groups.

In certain embodiments, urease inhibitors are N-(alkyl)thiophosphoric triamide urease inhibitors as described in U.S. Pat. No. 4,530,714 to Kolc et al., which is incorporated herein by reference in its entirety. Particular illustrative urease inhibitors can include, but are not limited to, N-(n-butyl)thiophosphoric triamide, N-(n-butyl)phosphoric triamide, N-(n-propyl)thiophosphoric triamide, N-(n-propyl)phosphoric triamide, thiophosphoryl triamide, phenyl phosphorodiamidate, cyclohexyl phosphoric triamide, cyclohexyl thiophosphoric triamide, phosphoric triamide, N-(2-nitrophenyl)phosphoric triamide, N-(2-pyrimidinyl)thiophosphoric triamide, N-phenylphosphoric triamide, 1,1,3,3,3-pentaamino-1λ5, 3λ5-diphosphaz-2-ene, hydroquinone, p-benzoquinone, hexamidocyclotriphosphazene, thiopyridines, thiopyrimidines, thiopyridine-N-oxides, N,N-dihalo-2-imidazolinone, N-halo-2-oxazolidinone, derivatives thereof, or any combination thereof. Other examples of urease inhibitors include phenylphosphorodiamidate (PPD/PPDA), hydroquinone, N-(2-nitrophenyl) phosphoric acid triamide (2-NPT), ammonium thiosulphate (ATS) and organo-phosphorous analogs of urea, which are effective inhibitors of urease activity (see e.g. Kiss and Simihaian, Improving Efficiency of Urea Fertilizers by Inhibition of Soil Urease Activity. Kluwer Academic Publishers, Dordrecht, The Netherlands, 2002; Watson, Urease inhibitors. IFA International Workshop on Enhanced-Efficiency Fertilizers, Frankfurt. International Fertilizer Industry Association, Paris, France 2005).

In particular embodiments, the urease inhibitor can be or can include N-(n-butyl)thiophosphoric triamide (NBPT). The preparation of phosphoramide urease inhibitors such as NBPT can be accomplished, for example, by known methods starting from thiophosphoryl chloride, primary or secondary amines and ammonia, as described, for example, in U.S. Pat. No. 5,770,771, which is incorporated herein by reference. In a first step, thiophosphoryl chloride is reacted with one equivalent of a primary or secondary amine in the presence of a base, and the product is subsequently reacted with an excess of ammonia to give the end product. Other methods include those described in U.S. Pat. No. 8,075,659 to Wissemeier et al., which is incorporated herein by reference, where thiophosphoryl chloride is reacted with a primary and/or secondary amine and subsequently with ammonia. However, this method can result in mixtures. Accordingly, when N-(n-butyl)thiophosphoric triamide (NBPT) or other urease inhibitors are used, it should be understood that this refers not only to the urease inhibitor in its pure form, but also to various commercial/industrial grades of the compound, which can contain up to 50 percent (or less), preferably not more than 20 percent, of impurities, depending on the method of synthesis and purification scheme(s), if any, employed in the production thereof. Combinations of urease inhibitors, for example using mixtures of NBPT and other alkyl-substituted thiophosphoric triamides, are known.

Representative grades of urease inhibitor may contain up to about 50 wt. %, about 40% about 30%, about 20% about 19 wt. %, about 18 wt. %, about 17 wt. %, about 16 wt. %, about 15 wt. %, about 14 wt. %, about 13 wt. %, about 12 wt. %, about 11 wt. %, 10 wt. %, about 9 wt. %, about 8 wt. %, about 7 wt. %, about 6 wt. % about 5 wt. %, about 4 wt. %, about 3 wt. %, about 2 wt. %, or about 1 wt. % impurities, depending on the method of synthesis and purification scheme(s), if any, employed in the production of the urease inhibitor. A typical impurity in NBPT is PO(NH₂)₃ which can catalyze the decomposition of NBPT under aqueous conditions. Thus in some embodiments, the urease inhibitor used is about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99%, about 99.1%, about 99.2%, about 99.3%, about 99.4%, about 99.5%, about 99.6%, about 99.7%, about 99.8%, or about 99.9% pure.

For simplicity, the urease inhibitor adducts may be described in relation to embodiments wherein NBPT is the urease inhibitor. Description of the urease inhibitor adducts in terms wherein NBPT is the urease inhibitor should not be viewed as necessarily excluding the use of other urease inhibitors, or combinations of urease inhibitors, unless expressly noted.

The urea used to produce urease inhibitor adducts can be in various forms. For example, the urea can be a solid in the form of prills, flakes, granules, and the like, and/or a solution, such as an aqueous solution, and/or in the form of molten urea. At least a portion of the urea can be in the form of animal waste. Both urea and combined urea-formaldehyde products can be used according to the present disclosure. Illustrative urea-formaldehyde products can include, but are not limited to, urea-formaldehyde concentrate (“UFC”) and urea-formaldehyde polymers (“UFP”). These types of products can be as discussed and described in U.S. Pat. Nos. 5,362,842 and 5,389,716 to Graves et al., for example, which are incorporated herein by reference. Any form of urea or urea in combination with formaldehyde can be used to make a UFP. Examples of solid UFP include PERGOPAK M® 2, available from Albemarle Corporation and NITAMIN 36S, available from Koch Agronomic Services, LLC. The urea source can be or can include animal waste such as urine and/or manure deposited on and/or in the soil or the nitrogen source can be or can include a fertilizer product previously applied to the soil. In another example, the urea source can be or can include animal waste such as urine and/or manure that can be collected and placed within a holding tank, pond, or the like, and the reaction product can be added to the animal waste to provide a mixture. The resulting mixture can then be deposited about the soil to act as a fertilizer therein.

Any of these urea sources can be used alone or in any combination to prepare the reaction product disclosed herein.

Aldehydes that can, in some embodiments, be used as a reagent in forming the adducts described herein can vary. For example, such aldehydes include, but are not limited to, formaldehyde, acetaldehyde, propionaldehyde, butyraldehyde, isobutyraldehyde, 2-methyl butanal, 2-ethyl butanal, pentanal, benzaldehyde, furfural, and analogues thereof. Aldehydes include, in some embodiments, dialdehydes, including but not limited to, glyoxal, malondialdehyde, succindialdehyde, glutaraldehyde, and analogues thereof. The aldehyde can optionally be provided in combination with urea (e.g., in the form of a mixture or polymer with urea). In some such embodiments, formaldehyde is used, and additional formaldehyde need not be added to form the desired adduct, although the disclosure is not limited thereto, and it is possible to add additional formaldehyde (and/or another type of aldehyde) to such urea-formaldehyde products. Accordingly, although aldehydes, including formaldehyde, are described herein as a separate, independent reagent to produce certain adducts disclosed herein, it is noted that in certain embodiments, formaldehyde (or formaldehyde equivalents) incorporated within the adduct may be already present within the urea source (i.e., formaldehyde is not intentionally added to the reaction).

Where the aldehyde is intentionally added as a reagent to prepare adducts disclosed herein, the aldehyde can be in various forms. For example, where the added aldehyde comprises formaldehyde, the formaldehyde can be provided in the form of paraform (solid, polymerized formaldehyde) and/or formalin solutions (aqueous solutions of formaldehyde, sometimes with methanol, in about 10 wt. %, about 20 wt. %, about 37 wt. %, about 40 wt. %, or about 50 wt. %, based on the weight of the formalin solution) are commonly used forms of formaldehyde. In some embodiments, the formaldehyde can be an aqueous solution having a concentration of formaldehyde ranging from about 10 wt. % to about 50 wt. % based on total weight of the aqueous solution. Formaldehyde gas can also be used. Formaldehyde substituted in part or in whole with substituted aldehydes such as acetaldehyde and/or propylaldehyde can also be used as the source of formaldehyde. Any of these forms of formaldehyde sources can be used alone or in any combination to prepare certain adducts described herein.

Urease inhibitor adducts can be produced in various ways. Generally, the urease inhibitor is combined with, mixed, or otherwise contacted with urea and/or an aldehyde. For example, an adduct can be produced by combining a urease inhibitor with urea and/or an aldehyde such that at least one adduct is formed. For example, at least a portion of the urease inhibitor can react with at least a portion of the urea and/or at least a portion of the aldehyde to form one or more structurally different adducts, as will be described further hereinafter.

The reactants (i.e., the urease inhibitor and urea and/or aldehyde) can be combined with one another in any order or sequence. For example, in one embodiment, urea and the aldehyde are first combined, and a urease inhibitor is added thereto. In another embodiment, urea and a urea formaldehyde product (e.g., urea formaldehyde concentrate or urea-formaldehyde polymer) are combined and the urease inhibitor is added thereto. In a further embodiment, a urea formaldehyde product and an aldehyde are combined, and the urease inhibitor is added thereto. In a still further embodiment, urea and the urease inhibitor are combined and an aldehyde or a urea formaldehyde product is added thereto. In certain embodiments, other components can be included at any of these stages, alone, or in combination with the urea, the aldehyde, and/or the urease inhibitor. For example, in some embodiments, a nitrification inhibitor (such as those disclosed herein below) can be combined with one or more of the components, e.g., including but not limited to, embodiments wherein the nitrification inhibitor is combined with the urease inhibitor and this mixture is combined with the other components.

In these various embodiments, the form of the urease inhibitor added can vary. For example, the urease inhibitor can be used in molten liquid form, in solution form, or in suspension/dispersion form. Similarly, the form of the material with which the urease inhibitor is combined (i.e., the urea/aldehyde mixture, the urea/urea formaldehyde product mixture, or the urea formaldehyde product/aldehyde mixture) can vary. For example, in some embodiments, the material with which the urease inhibitor is combined can be in solution form, can be in dispersion/suspension form, or can be in the form of a molten urea liquid. In any case, the form of the urease inhibitor, urea, and aldehyde should allow for a high degree of contact between these reagents to facilitate the reaction and formation of adducts.

Where solvents are used at any stage of the combining process to form adducts as disclosed herein, the solvents employed are generally those sufficient to solubilize one or more of the urease inhibitor, urea, and/or aldehyde. Suitable solvents can include, for example, water (including aqueous buffers), N-alkyl-2-pyrrolidones (e.g., N-methyl-2-pyrrolidone or N-butyl-2-pyrrolidone commercialized as TAMISOLVE® NxG), glycols and glycol derivatives, ethyl acetate, acetonitrile, propylene glycol, benzyl alcohol, and combinations thereof. Representative solvents known to solubilize NBPT include, but are not limited to, those solvents described in U.S. Pat. Nos. 5,352,265 and 5,364,438 to Weston, U.S. Pat. No. 5,698,003 to Omilinsky et al., U.S. Pat. Nos. 8,048,189 and 8,888,886 to Whitehurst et al., International Application Publication Nos. WO2014/100561 to Ortiz-Suarez et al., WO2014/055132 to McNight et al., WO2014/028775 and WO2014/028767 to Gabrielson et al., and EP2032589 to Cigler, which are incorporated herein by reference in their entireties. In certain embodiments, the solvent, or mixture of solvents, employed to combine the components can be selected from the group consisting of water (including buffered solutions, e.g., phosphate buffered solutions), glycols (e.g., propylene glycol), glycol derivatives and protected glycols (e.g., glycerol including protected glycerols such as isopropylidene glycerol, glycol ethers e.g. monoalkyl glycol ethers, dialkyl glycol ethers), acetonitrile, DMSO, alkanolamines (e.g., triethanolamine, diethanolamine, monoethanolamine, alkyldiethanolamines, dialkylmonoethanolamines, wherein the alkyl group can consist of methyl, ethyl, propyl, or any branched or unbranched alkyl chain), alkylsulfones (e.g., sulfolane), alkyl amides (e.g., N-2-methylpyrrolidone, N-2-butylpyrrolidone, N-2-ethylpyrrolidone, N,N-dimethylformamide, or any non-cyclic amide), monoalcohols (e.g., methanol, ethanol, propanol, isopropanol, benzyl alcohol. 2-ethylhexanol), dibasic esters and derivatives thereof, alkylene carbonates (e.g., ethylene carbonate, propylene carbonate), monobasic esters (e.g., ethyl lactate, ethyl acetate), carboxylic acids (e.g., maleic acid, oleic acid, itaconic acid, acrylic acid, methacrylic acid), phosphates (e.g., triethylphosphate), glycol esters, (−)-Dihydrolevoglucosenone (commercialized as CYRENE™) and/or surfactants (e.g. alkylbenzenesulfonates, alkyldiphenyloxide disulfonates, lignin sulfonates, alkylphenol ethoxylates, polyalkoxylated amines) and combinations thereof. Further co-solvents, including but not limited to, liquid amides, 2-pyrrolidone, N-alkyl-2-pyrrolidones, and ionic or non-ionic surfactants (e.g., alkylaryl polyether alcohols) can be used in certain embodiments.

Various other additives that do not negatively impact the formation of the adducts disclosed herein can be included in the reaction mixture to form the adducts (i.e., urease inhibitor(s), urea, aldehyde, and optional solvent(s)). For example, components (e.g., impurities) that are generally present in urea and/or the aldehyde are commonly incorporated in the reaction mixture. In some embodiments, components that are desirably included in the final product can be incorporated into the reaction mixture (e.g., dyes, as described in further detail below).

In certain embodiments, monoammonium phosphate (MAP), diammonium phosphate (DAP), and/or ammonium sulfate (AMS) can be used to promote the formation of adducts. Although not intended to be limiting, it is believed that MAP, DAP, or AMS can function as catalysts to facilitate the formation of adducts disclosed herein. In some embodiments, it may be possible, by including MAP, DAP, and/or AMS (and/or other catalysts), to reduce the reaction time and/or to conduct the reaction at lower temperatures than would otherwise be required to form the adducts. In certain embodiments, mixing granules of urease inhibitor-treated urea with granules of MAP, DAP or AMS also accelerates formation of certain adducts disclosed herein as compared with embodiments wherein no catalyst is employed. In some embodiments, the use of a particular catalyst may have an effect on the amount and/or type(s) of various adducts formed during the reaction.

Adduct formation can be conducted at various pH values, and in some embodiments, it may be desirable to adjust the pH of the reaction mixture (e.g., by adding acid and/or base). Representative acids include, but are not limited to, solutions of mineral acids such as hydrochloric acid, sulfuric acid, nitric acid, phosphoric acid, and combinations thereof. Exemplary bases include, but are not limited to, solutions of ammonia, amines (e.g., primary, secondary and tertiary amines and polyamines), sodium hydroxide, potassium hydroxide, and combinations thereof. In some embodiments, it may be desirable to employ a buffer solution to control the pH of the reaction mixture. Representative buffer solutions include, but are not limited to, solutions of triethanolamine, sodium borate, potassium bicarbonate, sodium carbonate, and combinations thereof.

The conditions under which the urease inhibitor, urea, and aldehyde (and optionally, other additives) are combined can vary. For example, the reaction can be conducted at various temperatures, e.g., ranging from ambient temperature (about 25° C.) to elevated temperatures (above 25° C.). In certain embodiments, the temperature at which the reaction is conducted is at least about 50° C., at least about 60° C., at least about 70° C., at least about 80° C., at least about 90° C., or at least about 100° C., such as about 20° C. to about 150° C.

Advantageously, in some embodiments, the reaction product can be prepared under conditions of conventional urea manufacturing (as described, for example, in Jozeef Meesen, Ullman's Encyclopedia of Industrial Chemistry (2012), vol. 37, pages 657-695, which is incorporated herein by reference). Such urea manufacturing conditions generally include temperatures at which urea is in molten form, e.g., temperatures of about 130° C. to about 135° C. For example, in such embodiments, the urease inhibitor can be added to a molten mixture of urea and an aldehyde (or urea and urea-formaldehyde (i.e., UF, UFC or UFP)). In another example, formaldehyde is first produced by the reaction of methanol with air. This is then absorbed in a urea and NBPT solution to form the reaction product. The mixture can be combined and then cooled to provide a reaction product comprising the reaction product, i.e., one or more adducts of urease inhibitor and urea and/or aldehyde. For example, the composition can be cooled by subjecting the reaction mixture to typical urea pastillation, prilling or granulation processes (e.g., fluidized bed granulation, drum granulation, sprouted bed granulation, and the like), which generally comprise a cooling step following formation of pastilles, prills and/or granules. Generally, the drying process provides the reaction product in the form of a solid material (e.g., a pastillated, granular or prilled solid).

The urease inhibitor, urea, and aldehyde (i.e., the reaction mixture) can be maintained together under the reaction conditions for various periods of time. For example, in some embodiments, the reaction can be conducted within a relatively short period (e.g., on the order of minutes, e.g., about 30 seconds to about 30 minutes, about 1 to about 20 minutes, or about 1 to about 10 minutes. In some embodiments, the reaction may be conducted for about 1 minute or longer, about 2 minutes or longer, about 5 minutes or longer, about 10 minutes or longer, about 15 minutes or longer, or about 20 minutes or longer. In certain embodiments, the reaction can be conducted for about 2 hours or less, about 1 hour or less, about 30 minutes or less, about 25 minutes or less, about 20 minutes or less, about 15 minutes or less, or about 10 minutes or less. In some embodiments, the components can be reacted together for a somewhat longer period, e.g., for a period of about 2 hours or longer, about 4 hours or longer, about 6 hours or longer, about 8 hours or longer, about 10 hours or longer, about 12 hours or longer, about 14 hours or longer, about 16 hours or longer, about 18 hours or longer, about 20 hours or longer, about 22 hours or longer, or about 24 hours or longer. In some embodiments, the reaction time is about 2 hours to about 48 hours, such as about 4 hours to about 36 hours.

In certain embodiments, the amount of time for which the reaction is conducted may be that amount of time required to convert a given percentage of urease inhibitor in the reaction mixture to adduct form. For example, in one embodiment, the reaction mixture is reacted to about 10% or less free (i.e., unreacted) urease inhibitor by weight, based on total urease inhibitor added to the reaction mixture or to about 5% or less free urease inhibitor by weight, based on total urease inhibitor added to the reaction mixture. In another embodiment, the reaction mixture is reacted to about 40% or less free (i.e. unreacted) urease inhibitor by weight, based on the total urease inhibitor added to the reaction mixture, or to about 30% or less free urease inhibitor by weight, based on total urease inhibitor added to the reaction mixture, or to about 20% or less free urease inhibitor by weight, based on total urease inhibitor added to the reaction mixture. In yet another embodiment, the reaction mixture is reacted to about 2% or less free urease inhibitor by weight, based on total urease inhibitor added to the reaction mixture, or to about 1% or less free urease inhibitor by weight, based on total urease inhibitor added to the reaction mixture, or to about 0.1% or less free urease inhibitor by weight, based on total urease inhibitor added to the reaction mixture. In a further embodiment, the reaction mixture is reacted to about 50% (i.e. unreacted) urease inhibitor by weight, based on the total urease inhibitor added to the reaction mixture to create a 1:1 wt. % adduct:free urease inhibitor product (as measured by phosphorous content). In yet a further embodiment, the reaction mixture is reacted to create a weight ratio of adduct:free urease inhibitor product in the range from about 4:1 to 1:4 (as measured by phosphorous content), including 3:1 to 1:3, 2:1 to 1:2, and a 1:1. Accordingly, in some embodiments, the method of producing an adduct as described herein further comprises monitoring the amount of free urease inhibitor remaining over the course of the reaction and evaluating the completeness of reaction based on the amount of free urease inhibitor in comparison to the desired maximum content of free urease inhibitor by weight to be included in the reaction product.

It is noted that the particular reaction components may affect the reaction conditions required to produce the reaction product. For example, reaction of components in one solvent may be more efficient than reaction of those components in a different solvent and it is understood that, accordingly, less time and/or lower temperature may be required for adduct formation in the former case. Also, where a catalyst is employed, less time and/or lower temperature may be required for adduct formation. It is also noted that, in some embodiments, employing different reaction conditions can have an effect on the amount and/or type(s) of various adducts formed during the reaction.

The reaction products provided according to the methods referenced hereinabove can comprise one or a plurality of structurally different adducts. For example, a given reaction product can comprise at least one adduct, at least two different adducts, at least three different adducts, at least four different adducts, at least five different adducts, at least ten different adducts, at least twenty-five different adducts, at least about fifty different adducts, or at least about one hundred different adducts. The adducts may be in the form of discrete compounds, oligomers, polymers, and combinations thereof. The overall amount of adduct formed can vary and, likewise, the amount of each different adduct (where more than one adduct is present in the composition) can vary.

Certain specific adducts that have been identified in reaction products based on reactions between urea, formaldehyde, and NBPT, are as follows (wherein the reference to these adducts as “Adduct 1,” “Adduct 2,” “Adduct 3,” and “Adduct 4” are arbitrary names chosen to distinguish them from one another and from other adducts that may be present in various reaction products). Further, one or more adduct dimers based on the reaction between NBPT, urea and formaldehyde have been identified, wherein the one or more adduct dimers are represented by the following structure:

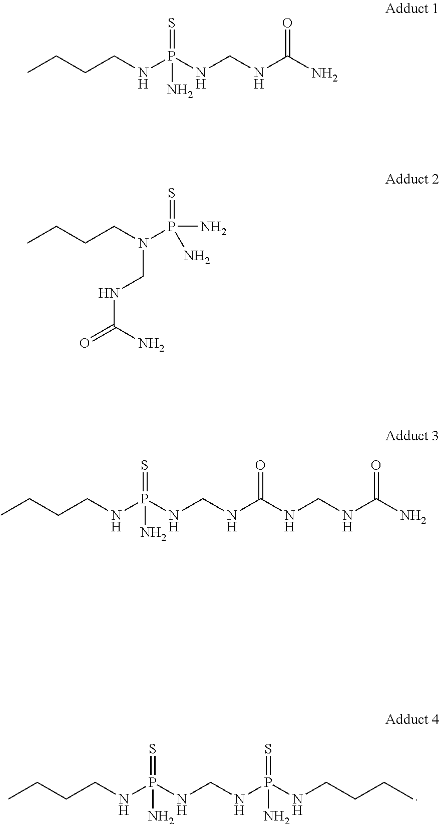 [SMILES: CCCCNP(N)(=S)NCNC(N)=O ; CCCCN(CNC(N)=O)P(N)(N)=S ; CCCCNP(N)(=S)NCNC(=O)NCNC(N)=O ; CCCCNP(N)(=S)NCNP(N)(=S)NCCCC]

The reaction product can comprise various other components in addition to the adduct(s). It is to be understood that other components that may be present in the reaction product can be a result of the specific method used to produce the reaction product and, particularly, of the amount of each reactant included in the reaction mixture. For example, where the reaction conditions are such that there is an excess of one or two reactants, the reaction product may comprise free reactant (i.e., reactant which is not incorporated into an adduct). In various embodiments, the reaction product can comprise at least some percent by weight of one or more components selected from the group consisting of free urease inhibitor (e.g., free NBPT), free aldehyde (e.g., free formaldehyde), free urea, free urea-aldehyde products (e.g., free urea-formaldehyde products, e.g., UFP), catalyst (e.g., MAP, DAP, or AMS), impurities (e.g., arising from the grade of reactants used), solvent, water, and combinations thereof. The relative amounts of such components can vary, with exemplary amounts and ratios disclosed below.

The reaction products can include widely varying mole percentages of urea, aldehyde, and urease inhibitor (including complexed and free forms of each component, e.g., as determined by elemental analysis). Similarly, the reaction products disclosed herein can have widely varying molar ratios, particularly as the method of producing the adducts can vary. In some specific embodiments, the reaction products have a molar ratio of about 1:0.5 to about 1:2 urease inhibitor:urea (including complexed and free forms of each component, e.g., as determined by elemental analysis). In certain embodiments, urea is used in great excess with respect to the urease inhibitor; consequently, in such embodiments, the molar ratio of urease inhibitor:urea is significantly lower. In some specific embodiments, the reaction products can have a molar ratio of about 1:0.5 to about 1:2 urease inhibitor:aldehyde (including complexed and free forms of each component, e.g., as determined by elemental analysis). Again, in some embodiments, the aldehyde is present in significant excess with respect to the urease inhibitor and, in such embodiments, the molar ratio of urease inhibitor:aldehyde is significantly lower.

The at least one urease inhibitor adduct is present in the formulation of the present disclosure in an amount of from about 10% to about 65% by weight of the total weight of the formulation. The urease inhibitor adduct may be present in the formulation of the present disclosure in an amount ranging from about 15% to about 60% by weight, such as from 20% to about 45%, such as from 25% to about 40%, or such as from 30% to about 35%. The urease inhibitor adduct may be present in the formulation of the present disclosure in an amount of about 10%. The urease inhibitor adduct may be present in the formulation of the present disclosure in an amount of about 15%. The urease inhibitor adduct may be present in the formulation of the present disclosure in an amount of about 20%. The urease inhibitor adduct may be present in the formulation of the present disclosure in an amount of about 25%. The urease inhibitor adduct may be present in the formulation of the present disclosure in an amount of about 30%. The urease inhibitor adduct may be present in the formulation of the present disclosure in an amount of about 35%. The urease inhibitor adduct may be present in the formulation of the present disclosure in an amount of about 40%. The urease inhibitor adduct may be present in the formulation of the present disclosure in an amount of about 45%. The urease inhibitor adduct may be present in the formulation of the present disclosure in an amount of about 50%. The urease inhibitor adduct may be present in the formulation of the present disclosure in an amount of about 55%. The urease inhibitor adduct may be present in the formulation of the present disclosure in an amount of about 65%.

The formulations of the present disclosure optionally include a solvent. In at least one embodiment, the solvent is present in the formulation of the present disclosure, in an amount of from about 5% to about 95% by weight of the total weight of the formulation. The solvent may be present in the formulation of the present disclosure in an amount ranging from about 10% to about 70% by weight, such as from about 20% to about 50%, such as from about 20% to about 40%, and such as from about 20% to about 30%. The solvent may be present in the formulation of the present disclosure in a range of about 10% to about 40%, such as from about 15% to about 35%, such as from about 20% to about 33%, or such as from about 25% to about 30%. In at least one embodiment, the solvent is present in the formulation of the present disclosure in an amount of about 10% by weight. In at least one embodiment, the solvent is present in the formulation of the present disclosure in an amount of about 12.5% by weight. In at least one embodiment, the solvent is present in the formulation of the present disclosure in an amount of about 15% by weight. In at least one embodiment, the solvent is present in the formulation of the present disclosure in an amount of about 17.5% by weight. In at least one embodiment, the solvent is present in the formulation of the present disclosure in an amount of about 20% by weight. In at least one embodiment, the solvent is present in the formulation of the present disclosure in an amount of about 22.5% by weight. In at least one embodiment, the solvent is present in the formulation of the present disclosure in an amount of about 25% by weight. In at least one embodiment, the solvent is present in the formulation of the present disclosure in an amount of about 27.5% by weight. In at least one embodiment, the solvent is present in the formulation of the present disclosure in an amount of about 30% by weight. In at least one embodiment, the solvent is present in the formulation of the present disclosure in an amount of about 32.5% by weight. In at least one embodiment, the solvent is present in the formulation of the present disclosure in an amount of about 35% by weight. In at least one embodiment, the solvent is present in the formulation of the present disclosure in an amount of about 37.5% by weight. In at least one embodiment, the solvent is present in the formulation of the present disclosure in an amount of about 40% by weight.

In at least one embodiment, the solvent is not present. In another embodiment, the solvent is DMSO. In the formulations of the present disclosure, the solvent may be combined with at least one of a glycol, glycol derivative and/or alkylene glycol alkyl ether.

In at least one embodiment, the solvent is chosen from a glycol or glycol derivative. Examples of glycols include, but are not limited to, ethylene glycol (commonly referred to as glycol), propylene glycol (PG) (1,2-propanediol), 1,4-butanediol, 1,5-pentanediol, 1,6-hexanediol, 1,10-decanediol, 1,7-heptanediol, 1,9-nonanediol, 1,8-octanediol, 1,3-propanediol, 1,3-butanediol, 1,4-butanediol, 2,3-butanediol, 2,4-pentanediol, 2,5-hexanediol, 4,5-octanediol, and 3,4-hexanediol. Other examples of glycols include, but are not limited to, diethylene glycol and dipropylene glycol. Examples of glycol derivatives include, but are not limited to, ethylene glycol monomethyl ether, ethylene glycol monoethyl ether, ethylene glycol monopropyl ether, ethylene glycol monoisopropyl ether, ethylene glycol monobutyl ether, ethylene glycol monophenyl ether, ethylene glycol monobenzyl ether, diethylene glycol monomethyl ether, diethylene glycol monoethyl ether, diethylene glycol mono-n-butyl ether, ethylene glycol dimethyl ether, ethylene glycol diethyl ether, ethylene glycol dibutyl ether, ethylene glycol methyl ether acetate, ethylene glycol monoethyl ether acetate, ethylene glycol monobutyl ether acetate, propylene glycol methyl ether acetate, ethylene glycol monostearate, ethylene glycol distearate, ethylene glycol amido stearate, propylene glycol monostearate, propylene glycol dicaprylate, propylene glycol dicaprate diacetate glycol, dilaurate glycol, dipalmite glycol, diformate glycol, dibutyrate glycol, dibenzorate glycol, dipalmate glycol, dipropionate glycol, monoacetate glycol, monopalmitate glycol, monoformate glycol, and diethylene glycol monostearate. Examples of glycol derivatives also include, but are not limited to, C₃-C₁₂ triols and/or C₃-C₁₂ triol derivatives, including C₃-C₆ triols, glycerol monostearate, glycerol distearate, glycerol monooleate, glycerol monolaurate, glycerol dilaurate, glycerol dipalmitate, glycerol monopalmitate, glycerol triacetate, glycerol tribenzoate, glycerol tributyrate, glycerol trimyristate, glycerol trioleate, glycerol trilaurate, glycerol tripalmitate, and glycerol tristearate.

The formulation of the present disclosure may also include an alkylene glycol alkyl ether. Examples of alkylene glycol alkyl ethers include, but are not limited to, diethylene glycol monoethyl ether, diethylene glycol monopropyl ether, diethylene glycol monopentylyl ether, diethylene glycol monoisopropyl ether, diethylene glycol monoisobutyl ether, diethylene glycol monohexyl ether, triethylene glycol monomethyl ether, triethylene glycol monopropyl ether, triethylene glycol monobuyl ether, triethylene glycol monopentyl ether, triethylene glycol monoisopropyl ether, triethylene glycol monoisobutyl ether, triethylene glycol monohexyl ether, tetraethylene glycol monomethyl ether, tetraethylene glycol monoethyl ether, tetraethylene glycol monopropyl ether, tetraethylene glycol monobutyl ether, tetraethylene glycol monopentyl ether, tetraethylene glycol monoisopropyl ether, tetraethylene glycol monoisobutyl ether, tetraethylene glycol monohexyl ether, dipropylene glycol monoethyl ether, dipropylene glycol monopropyl ether, dipropylene glycol monobutyl ether, dipropylene glycol monopentyl ether, dipropylene glycol monoisopropyl ether, dipropylene glycol monoisobutyl ether, dipropylene glycol monohexyl ether, tripropylene glycol monomethyl ether (MTPGE), tripropylene glycol monoethyl ether, tripropylene glycol monopropyl ether, tripropylene glycol monobutyl ether, tripropylene glycol monopentyl ether, tripropylene glycol monoisopropyl ether, tripropylene glycol monoisobutyl ether, tripropylene glycol monohexyl ether, triethylene glycol monobutyl ether (MTRGE), tetraethylene glycol monobutyl ether (MTEGE), diethylene glycol monobutyl ether (MDGE), and dipropylene glycol dimethyl ether (MDPG). In at least one embodiment, the alkylene glycol alkyl ether is triethylene glycol monobutyl ether.

In at least one embodiment, the formulation of the present disclosure does not contain N-methyl-2-pyrrolidone (NMP).

The formulation of the present disclosure may also include a dye. Examples of dyes include, but are not limited to, FD&C Blue No. 1, FD&C Green No. 3, FD&C Yellow No. 5, FD&C Red No. 3, FD&C Red No. 40, FD&C Yellow No. 6, and AGROTAIN® ULTRA green dye. In at least one embodiment, the dye, such as for example, AGROTAIN® ULTRA green dye, is present in the formulation of the present disclosure, in an amount of from about 0.01% to about 6% by weight of the total weight of the formulation. The dye may be present in the formulation of the present disclosure in an amount ranging from about 0.01% to about 6% by weight, such as from about 0.02% to about 6%, such as from about 0.05% to about 6%, such as from about 0.1% to about 6%, such as from about 0.5% to about 6%, such as from about 1% to about 6%, such as from about 2% to about 6%, such as from about 3% to about 6%, such as from about 4% to about 6%, such as from about 5% to about 6%, such as from about 0.01% to about 2%, such as from about 0.05% to about 2%, such as from about 0.1% to about 2%, such as from about 0.5% to about 2%, such as from about 1% to about 2%, such as from about 0.01% to about 1%, such as from 0.05% to 1%, such as from 0.1% to 1%, such as from 0.5% to 1%. In at least one embodiment, the dye is present in the formulation of the present disclosure in an amount of about 0.10% by weight. In at least one embodiment, the dye is present in the formulation of the present disclosure in an amount of about 0.16% by weight.

The formulation of the present disclosure may also include a nitrification inhibitor. As used herein, “nitrification inhibitor” refers to any compound that helps to retain fertilizer-applied nitrogen in soil in the form of ammonia. It delays the nitrification process by inhibiting the Nitrosomonas spp. bacteria that typically convert ammonia to nitrite, thus preventing the loss of soil nitrogen through leaching, runoff, or gaseous emissions. Examples of nitrification inhibitors include, but are not limited to, dicyandiamide (DCD), 2-chloro-6-trichloromethyl-pyridine, 5-ethoxy-3-trichloromethyl-1,2,4-thiadiazol, dicyandiamide, 2-amino-4-chloro-6-methyl-pyrimidine, 1,3-benzothiazole-2-thiol, 4-amino-N-1,3-thiazol-2-ylbenzenesulfonamide, thiourea, guanidine, 3,4-dimethylpyrazole phosphate, 2,4-diamino-6-trichloromethyl-5-triazine, polyetherionophores, 4-amino-1,2,4-triazole, 3-mercapto-1,2,4-triazole, potassium azide, carbon bisulfide, Sodium trithiocarbonate, ammoniumdithiocarbamate, 2.3, dihydro-2,2-dimethyl-7-benzofuranol, methyl-carbamate, N-(2,6-dimethylphenyl)-N-(methoxyacetyl)-alanine methyl ester, ammonium thiosulfate, 1-hydroxypyrazole, 2-methylpyrazole-1-carboxamide, dimethyl-1H-pyrazol-1-yl)succinic acid and 2-(4,5-dimethyl-1H-pyrazol-1-yl)succinic acid derivatives thereof, and any combination thereof. In at least one embodiment, the nitrification inhibitor such as for example, DCD, is present in the formulation of the present disclosure, in an amount of from about 1% to about 50% by weight of the total weight of the formulation. The nitrification inhibitor may be present in the formulation of the present disclosure in an amount ranging from about 1% to about 50% by weight, such as from about 1% to about 40%, such as from about 1% to about 30%, such as from about 1% to about 20%, such as from about 1% to about 10%, such as from about 1% to about 5%. The nitrification inhibitor may be present in the formulation of the present disclosure in a range of about 5% to about 25%, about 5% to about 20%, or about 5% to about 10%. The nitrification inhibitor may be present in the formulation of the present disclosure in a range of about 10% to about 50%, such as about 10% to about 40%, such as about 10% to about 30%, and such as about 10% to about 20%.

The present disclosure also includes fertilizers, comprising at least one urease inhibitor adduct comprising a urease inhibitor with urea, formaldehyde, or both urea and formaldehyde; a urease inhibitor; and optionally a solvent; and a nitrogen source.

In at least one embodiment, the nitrogen source, such as urea, is present in the fertilizer of the present disclosure, in an amount of from about 1% to about 50% by weight of the total weight of the fertilizer. A nitrogen source may be present in the fertilizer of the present disclosure in an amount ranging from about 1% to about 50% by weight, such as from about 1% to about 40%, such as from about 1% to about 30%, such as from about 1% to about 20%, such as from about 1% to about 10%, such as from about 1% to about 5%. A nitrogen source may be present in the fertilizer of the present disclosure in a range of about 5% to about 25%, about 5% to about 20%, or about 5% to about 10%. A nitrogen source may be present in the fertilizer of the present disclosure in a range of about 10% to about 50%, such as about 10% to about 40%, such as about 10% to about 30%, and such as about 10% to about 20%.

The fertilizer of the present disclosure may further include formaldehyde. In at least one embodiment, formaldehyde is present in an amount of from about 1% to about 50% by weight of the total weight of the fertilizer. Formaldehyde may be present in the fertilizer of the present disclosure in an amount ranging from about 1% to about 50% by weight, such as from about 1% to about 40%, such as from about 1% to about 30%, such as from about 1% to about 20%, such as from about 1% to about 10%, such as from about 1% to about 5%. Formaldehyde may be present in the fertilizer of the present disclosure in a range of about 5% to about 25%, about 5% to about 20%, or about 5% to about 10%. Formaldehyde may be present in the fertilizer of the present disclosure in a range of about 10% to about 50%, such as about 10% to about 40%, such as about 10% to about 30%, and such as about 10% to about 20%.

The fertilizer of the present disclosure may also include one or more excipients or additives. The excipient may be water, a surfactant, a solvent, or any combination thereof. In at least one embodiment, the surfactant is selected from octylphenol polyether alcohol, 2-ethylhexanol, sulfosuccinate, naphthalene sulfonate, sulfated ester, phosphate ester (e.g. triethylphosphate), sulfated alcohol, alkyl benzene sulfonate, alkyldiphenyloxide disulfonates, polycarboxylate, naphthalene sulfonate condensate, phenol sulfonic acid condensate, lignosulfonate, methyl oleyl taurate, polyvinyl alcohol, or any combination thereof. Examples of additives include but are not limited to: conditioners; xanthan gum; calcium carbonate (agricultural lime) in its various forms for adding weight and/or raising the pH of acidic soils; metal containing compounds and minerals such as gypsum, metal silicates, and chelates of various micronutrient metals such as iron, zinc and manganese; talc; elemental sulfur; activated carbon, which may act as a “safener” to protect against potentially harmful chemicals in the soil; plant protectants; nutrients; nutrient stabilizers; super absorbent polymers; wicking agents; wetting agents; plant stimulants to accelerate growth; inorganic nitrogen, phosphorus, potassium (N-P-K) type fertilizers; sources of phosphorus; sources of potassium; organic fertilizers; surfactants, such as alkylaryl polyether alcohols; initiators; stabilizers; cross linkers; antioxidants; UV stabilizers; reducing agents; dyes, such as blue dye (FD & C blue #1); pesticides; herbicides; fungicides; biocides; and plasticizers. Examples of conditioners include but are not limited to tricalcium phosphate, sodium bicarbonate, sodium ferricyanide, potassium ferricyanide, bone phosphate, sodium silicate, silicon dioxide, calcium silicate, talcum powder, bentonite, calcium aluminum silicate, stearic acid, and polyacrylate powder. Examples of plant protectants and nutrient stabilizers include silicon dioxide and the like. Examples of nutrients include, but are not limited to, phosphorus and potassium-based nutrients. A commercially available fertilizer nutrient can include, for example, K-Fol 0-40-53, which is a solution that contains 40 wt. % phosphate and 53 wt. % potassium, which is manufactured and distributed by GBS Biosciences, LLC. The content of the additional additives disclosed herein can be from about 1 to about 75 percent by weight of the composition and depends, in part, on the desired function of the additional additives and the makeup of the fertilizer.

The present disclosure also includes methods for fertilizing soil. In at least one embodiment, the soil may be treated by contacting it directly with a formulation or fertilizer of the present disclosure. In at least one embodiment, contacting the soil with a formulation or fertilizer of the present disclosure may comprise administering a formulation or fertilizer of the present disclosure as a spray. In another embodiment, contacting the soil with a formulation or fertilizer of the present disclosure may comprise administering a formulation or fertilizer of the present disclosure as granules. In at least one embodiment, contacting the soil comprises administering a formulation or fertilizer of the present disclosure as a powder. In at least one embodiment, contacting the soil comprises adding a formulation or fertilizer of the present disclosure to the irrigation water for the soil.

The formulations and fertilizers of the present disclosure can broadly be used in all agricultural applications in which urea is currently used. These applications include a very wide range of crop and turf species, tillage systems, and fertilizer placement methods. The compositions disclosed herein are useful for fertilizing a wide variety of seeds and plants, including seeds used to grow crops for human consumption, for silage, or for other agricultural uses. Indeed, virtually any seed or plant can be treated in accordance with the present disclosure using the compositions of the present disclosure, such as cereals, vegetables, ornamentals, conifers, coffee, turf grasses, forages and fruits, including citrus. Plants that can be treated include grains such as barley, oats and corn, sunflower, sugar beets, rape, safflower, flax, canary grass, tomatoes, cotton seed, peanuts, soybean, wheat, rice, alfalfa, sorghum, bean, sugar cane, broccoli, cabbage and carrot. Application of a reaction product containing a significant urea concentration to soil and/or plants can increase the nitrogen uptake by plants, enhance crop yields, and minimize the loss of nitrogen from the soil, while providing for enhanced urease inhibitor stability.

The urease inhibitor formulations of the present disclosure are stable and do not exhibit crystallization at low temperatures, such as at 0° C. or below. The urease inhibitor formulations of the present disclosure are stable at such low temperatures for extended periods of time, including for example, during storage. In other words, the urease inhibitor formulations of the present disclosure remain in liquid form at low temperatures and/or for extended periods of time, such as for example, at least 2 weeks, at least one month, at least 6 months, at least one year, or at least 1.5 years.

The term “temperature of 0° C. or below” means a temperature range from about −20° C. to about 0° C.

The urease inhibitor formulations of the present disclosure are stable and have a freezing point that ranges from about −20° C. to about 0° C. The formulations of the present disclosure may exhibit a freezing point that ranges from about −15° C. to about 0° C., such as from about −10° C. to about 0° C., such as from about −5° C. to about 0° C. In at least one embodiment, the freezing point of the formulations of the present disclosure is about −20° C. In at least one embodiment, the freezing point of the formulations of the present disclosure is about −18° C. In at least one embodiment, the freezing point of the formulations of the present disclosure is about −16° C. In at least one embodiment, the freezing point of the formulations of the present disclosure is about −14° C. In at least one embodiment, the freezing point of the formulations of the present disclosure is about −12.5° C. In at least one embodiment, the freezing point of the formulations of the present disclosure is about −12° C. In at least one embodiment, the freezing point of the formulations of the present disclosure is about −11.5° C. In at least one embodiment, the freezing point of the formulations of the present disclosure is about −11° C. In at least one embodiment, the freezing point of the formulations of the present disclosure is about −10° C. In at least one embodiment, the freezing point of the formulations of the present disclosure is about −8.5° C. In at least one embodiment, the freezing point of the formulations of the present disclosure is about −8° C. In at least one embodiment, the freezing point of the formulations of the present disclosure is about −6° C. In at least one embodiment, the freezing point of the formulations of the present disclosure is about −5° C. In at least one embodiment, the freezing point of the formulations of the present disclosure is about −2.5° C.

The urease inhibitor formulations of the present disclosure are stable meaning they exhibit substantially no freezing of the formulation and/or crystallization, such that less than about 5% of the total solution is frozen and/or less than about 5% of total solids crystallize out from solution at a temperature of 0° C. or below.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other acceptable order.

### EXAMPLES

### Example 1

### Synthetic Preparation of Urease Inhibitor Adduct Solid Material

To a 50 L-jacketed reactor equipped with overhead stirring and thermocouple probe were charged NBPT (9.1 kg) and ethyl acetate (14.66 kg). To the fine white suspension was added urea (3268.6 g, 54.4 moles). Formalin (3268.3 g, 54.4 moles; 50% solution) was added to the suspension. The reaction was stirred overnight at 23° C. jacket temperature. The solvent was evaporated, and the product was further dried to constant weight, to afford a honey-like material that constituted urease inhibitor adduct solid material.

### Example 2

### Synthetic Preparation of Liquid Formulation (Sample Entry A3)

Urease inhibitor adduct solid material (40 wt. %) was charged into a glass jar equipped with a stir bar. Subsequently, NBPT (30 wt. %) and dye (0.67 wt. %) were added, followed by DMSO (29.33 wt. %). The mixture was stirred at 50° C. to ensured that urease inhibitor adduct solid material was fully dissolved in the solution. This mixture was stirred for 3 h.

Formulations in the following table were prepared according to Examples 1 and 2 using appropriate amounts of urease inhibitor adduct solid material and the remaining components.

| | | Wt. % of | | |
|---|---|---|---|---|
| | | urease | | |
| | | inhibitor | Wt. % of | Freezing Point |
| Entry | Formulation | adduct | DMSO | (° C.) |
| A1 | 30 wt. % NBPT, | 0 | 69.33 | −11.5 |
| | 0.67% dye | | | |
| A2 | 30 wt. % NBPT, | 20 | 49.33 | −16.0 |
| | 0.67% dye | | | |
| A3 | 30 wt. % NBPT, | 40 | 29.33 | −12.5 |
| | 0.67% dye | | | |
| A4 | 30 wt. % NBPT, | 60 | 9.33 | −8.5 |
| | 0.67% dye | | | |

### Example 3

### Freeze Point Measurement Method

Freeze point determination was performed according to ASTM method D2386-03.
1. Measure out 25±1 mL of the solution and transfer it to the clean, dry, jacketed sample tube. Close the tube tightly with the cork holding the stirrer, thermometer, and moisture proof collar and adjust the thermometer position so that its bulb does not touch the walls of the tube flask and is approximately in the center. The bulb of the thermometer should be 10 to 15 mm from the bottom of the sample tube.
2. Clamp the jacketed sample tube so that it extends as far as possible into the vacuum flask containing the cooling medium. The surface of the sample should be approximately 15 to 20 mm below the level of the coolant. Unless the medium is cooled by mechanical refrigeration, add solid carbon dioxide as necessary throughout the test to maintain the coolant level in the vacuum flask.
3. Stir the solution continuously, moving the stirrer up and down at the rate of 1 to 1.5 cycles/s, except when making observations, taking care that the stirrer loops approach the bottom of the flask on the downstroke and remain below the fuel surface on the upstroke. Disregard any cloud that appears at approximately −10° C. and does not increase in intensity as the temperature is lowered, because this is due to water. Record the temperature at which crystals appear. Remove the jacketed sample tube from the coolant and allow the sample to warm, stirring it continuously at 1 to 1.5 cycles/s. Record the temperature at which the crystals completely disappear.

The freezing points of the formulations from the table above (entries A1-A4) were measured according to this procedure and the results are shown in the table.

The present disclosure includes the following embodiments:
1. A formulation comprising:
   (i) a urease inhibitor adduct comprising a urease inhibitor with urea, formaldehyde, or both urea and formaldehyde; and
   (ii) a urease inhibitor, wherein the composition has a freezing point ranging from −20° C. to 0° C.
2. The formulation of embodiment 1, wherein the composition does not contain N-methyl-2-pyrrolidone (NMP).
3. The formulation of embodiments 1 or 2, wherein the urease inhibitor is chosen from N-(n-butyl)thiophosphoric triamide, N-(n-butyl)phosphoric triamide, N-(n-propyl)thiophosphoric triamide, N-(n-propyl)phosphoric triamide, thiophosphoryl triamide, phenyl phosphorodiamidate, cyclohexyl phosphoric triamide, cyclohexyl thiophosphoric triamide, phosphoric triamide, hydroquinone, N-(2-nitrophenyl)phosphoric triamide, N-(2-pyrimidinyl)thiophosphoric triamide, N-phenylphosphoric triamide, 1,1,3,3,3-pentaamino-1λ5, 3λ5-diphosphaz-2-ene, p-benzoquinone, hexamidocyclotriphosphazene, thiopyridines, thiopyrimidines, thiopyridine-N-oxides, N,N-dihalo-2-imidazolinone, N-halo-2-oxazolidinone, phenylphosphorodiamidate (PPD/PPDA), hydroquinone, N-(2-nitrophenyl) phosphoric acid triamide (2-NPT), ammonium thiosulphate (ATS), organo-phosphorous analogs of urea, and derivatives and combinations thereof.
4. The formulation of any one of the preceding embodiments, wherein the urease inhibitor is N-(n-butyl)phosphoric triamide (NBPT).
5. The formulation of any one of the preceding embodiments, wherein the urease inhibitor adduct is chosen from one of Adduct 1, Adduct 2, Adduct 3, and Adduct 4:

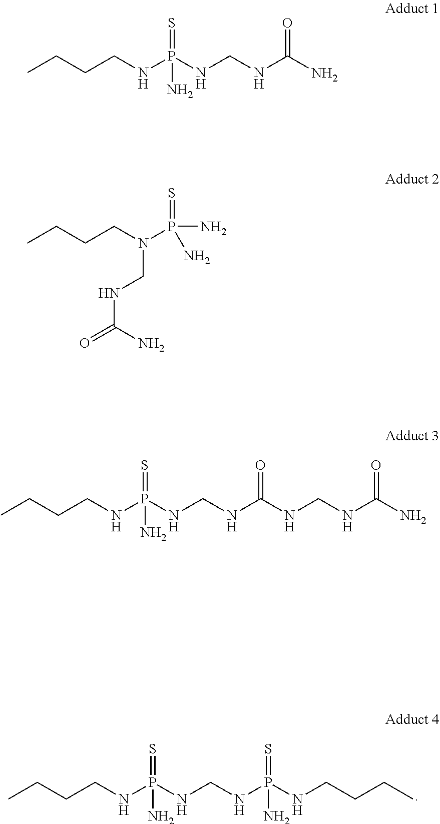 [SMILES: CCCCNP(N)(=S)NCNC(N)=O ; CCCCN(CNC(N)=O)P(N)(N)=S ; CCCCNP(N)(=S)NCNC(=O)NCNC(N)=O ; CCCCNP(N)(=S)NCNP(N)(=S)NCCCC]

6. The formulation of any one of the preceding embodiments, further comprising a solvent.
7. The formulation of embodiment 6, wherein the solvent is chosen from dimethyl sulfoxide (DMSO) or an alkylene glycol alkyl ether.
8. The formulation of embodiment 7, wherein the glycol ether is triethylene glycol monobutyl ether.
9. The formulation of any one of the preceding embodiments, wherein the freezing point ranges from about −15° C. to about 0° C.
10. The formulation of any one of the preceding embodiments, wherein the freezing point ranges from about −15° C. to about −10° C.
11. The formulation of any one of the preceding embodiments, wherein the freezing point is about −15° C.
12. The formulation of any one of the preceding embodiments, wherein the freezing point is about −10° C.
13. The formulation of any one of the preceding embodiments, wherein the urease inhibitor adduct is present in an amount ranging from 5% to 75% by weight of the total composition.
14. The formulation of any one of the preceding embodiments, wherein the urease inhibitor adduct is present in an amount ranging from 10% to 65% by weight of the total composition.
15. The formulation of any one of the preceding embodiments, wherein the urease inhibitor adduct is present in an amount ranging from 15% to 60% by weight of the total composition.
16. The formulation of any one of the preceding embodiments, wherein the urease inhibitor adduct is present in an amount ranging from 20% to 45% by weight of the total composition.
17. The formulation of any one of the preceding embodiments, wherein the urease inhibitor adduct is present in an amount of about 20% by weight of the total composition.
18. The formulation of any one of the preceding embodiments, wherein the urease inhibitor adduct is present in an amount of about 40% by weight of the total composition.
19. The formulation of any one of the preceding embodiments, wherein the urease inhibitor is present in an amount ranging from 5% to 95% by weight of the total composition.
20. The formulation of any one of the preceding embodiments, wherein the urease inhibitor is present in an amount of about 30% by weight of the total composition.
21. The formulation of any one of the preceding embodiments, wherein the solvent is present in an amount ranging from 5% to 95% by weight of the total composition.
22. The formulation of any one of the preceding embodiments, wherein the solvent is present in an amount ranging from about 10% to about 70% by weight of the total composition.
23. The formulation of any one of the preceding embodiments, wherein the solvent is present in an amount ranging from about 20% to about 50% by weight of the total composition.
24. The formulation of any one of the preceding embodiments, wherein the solvent is present in an amount of about 50% by weight of the total composition.
25. A fertilizer comprising a formulation of any one of the preceding embodiments and a nitrogen source.
26. The fertilizer of embodiment 25, wherein the nitrogen source is urea.
27. The fertilizer of embodiments 25 or 26, further comprising formaldehyde.
28. The fertilizer of any one of embodiments 25-27, further comprising a nitrification inhibitor.
29. The fertilizer of any one of embodiments 25-28, further comprising an additive. 30. The fertilizer of embodiment 29, wherein the additive is FD&C Blue No. 1, FD&C Green No. 3, FD&C Yellow No. 5, FD&C Red No. 3, FD&C Red No. 40, FD&C Yellow No. 6, AGROTAIN® ULTRA green dye, octylphenol polyether alcohol, sulfosuccinate, naphthalene sulfonate, sulfated ester, phosphate ester, triethylphosphate, 2-ethylhaxanol, sulfated alcohol, alkyl benzene sulfonate, polycarboxylate, naphthalene sulfonate condensate, phenol sulfonic acid condensate, lignosulfonate, methyl oleyl taurate, polyvinyl alcohol, monoammonium phosphate (MAP), diammonium phosphate (DAP), ammonium sulfate (AMS).
31. A method of enhancing the low temperature stability of a urease inhibitor formulation comprising providing one or more urease inhibitor adducts comprising a urease inhibitor with urea, formaldehyde, or both urea and formaldehyde to a urease inhibitor and solvent.
32. A method of enhancing the low temperature stability of a urease inhibitor composition comprising providing a composition of embodiment 1.
33. The method of embodiments 31 or 32 wherein the formulation is stable at 0° C.
34. The method of any one of embodiments 31-33, wherein the formulation is stable for 2 weeks.
35. The method of any one of embodiments 31-34, wherein formulation is stable for about 1 month.
36. The method of any one of embodiments 31-35, wherein formulation is stable for about 6 months.
37. The method of any one of embodiments 31-36, wherein formulation is stable for 1 year.
38. The method of any one of embodiments 31-37, wherein less than about 5% of the total formulation is frozen.
39. The formulation of any one of embodiments 1-24, wherein less than about 5% of the total formulation is frozen.

1. A formulation comprising:
(i) a urease inhibitor adduct comprising a urease inhibitor with urea, formaldehyde, or both urea and formaldehyde; and
(ii) a urease inhibitor, wherein the composition has a freezing point ranging from −20° C. to 0° C.

2. The formulation of claim 1, wherein the composition does not contain N-methyl-2-pyrrolidone (NMP).

3. The formulation of claim 1, wherein the urease inhibitor chosen from N-(n-butyl)thiophosphoric triamide, N-(n-butyl)phosphoric triamide, N-(n-propyl)thiophosphoric triamide, N-(n-propyl)phosphoric triamide, thiophosphoryl triamide, phenyl phosphorodiamidate, cyclohexyl phosphoric triamide, cyclohexyl thiophosphoric triamide, phosphoric triamide, hydroquinone, N-(2-nitrophenyl)phosphoric triamide, N-(2-pyrimidinyl)thiophosphoric triamide, N-phenylphosphoric triamide, 1,1,3,3,3-pentaamino-1λ5, 3λ5-diphosphaz-2-ene, p-benzoquinone, hexamidocyclotriphosphazene, thiopyridines, thiopyrimidines, thiopyridine-N-oxides, N,N-dihalo-2-imidazolinone, N-halo-2-oxazolidinone, phenylphosphorodiamidate (PPD/PPDA), hydroquinone, N-(2-nitrophenyl) phosphoric acid triamide (2-NPT), ammonium thiosulphate (ATS), organo-phosphorous analogs of urea, and derivatives and combinations thereof.

4. The formulation of claim 1, wherein the urease inhibitor is N-(n-butyl)phosphoric triamide (NBPT).

5. The formulation of claim 1, wherein the urease inhibitor adduct is chosen from one of Adduct 1, Adduct 2, Adduct 3, and Adduct 4:

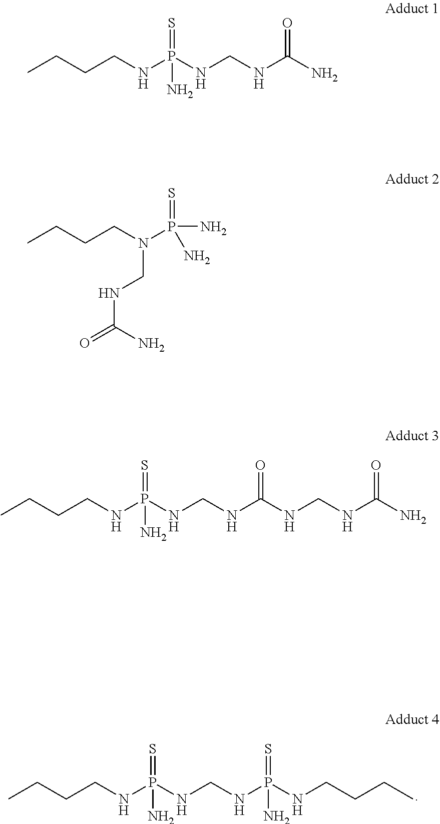 [SMILES: CCCCNP(N)(=S)NCNC(N)=O ; CCCCN(CNC(N)=O)P(N)(N)=S ; CCCCNP(N)(=S)NCNC(=O)NCNC(N)=O ; CCCCNP(N)(=S)NCNP(N)(=S)NCCCC]

6. The formulation of claim 1, further comprising a solvent.

7. The formulation of claim 6, wherein the solvent is chosen from dimethyl sulfoxide (DMSO) or an alkylene glycol alkyl ether.

8. The formulation of claim 1, wherein the urease inhibitor adduct is present in an amount ranging from 5% to 75% by weight of the total composition.

9. The formulation of claim 1, wherein the urease inhibitor is present in an amount ranging from 5% to 95% by weight of the total composition.

10. The formulation of claim 6, wherein the solvent is present in an amount ranging from 5% to 95% by weight of the total composition.

11. A fertilizer comprising a formulation of claim 1 and a nitrogen source.

12. The fertilizer of claim 11, further comprising formaldehyde and/or a nitrification inhibitor and/or an additive.

13. A method of enhancing the low temperature stability of a urease inhibitor formulation comprising providing one or more urease inhibitor adducts comprising a urease inhibitor with urea, formaldehyde, or both urea and formaldehyde to a urease inhibitor and solvent.

14. A method of enhancing the low temperature stability of a urease inhibitor composition comprising providing a formulation of claim 1.

15. The method of claims 13, wherein the formulation is stable for 2 weeks.

16. The method of claim 13, wherein formulation is stable for about 1 month.

17. The method of claim 13, wherein formulation is stable for about 6 months.

18. The method of claim 13, wherein formulation is stable for 1 year.

19. The method of claims 13, wherein less than about 5% of the total formulation is frozen.

20. The formulation of claim 1, wherein less than about 5% of the total formulation is frozen.
